(19) United States
(12) Patent Application Publication
(10) Pub. No.: US 2025/0329848 A1
(43) Pub. Date: Oct. 23, 2025

(54) BATTERY CASE FOR ELECTRIC VEHICLE, AND METHOD FOR MANUFACTURING SAME

(71) Applicants: Kabushiki Kaisha Kobe Seiko Sho (Kobe Steel, Ltd.), Kobe-shi (JP); TOYOTA JIDOSHA KABUSHIKI KAISHA, Toyota-shi (JP)

(72) Inventors: Hideki ISHITOBI, Shimonoseki-shi (JP); Taiki YAMAKAWA, Shimonoseki-shi (JP); Shingo SHIMOAKA, Shimonoseki-shi (JP); Kouichi DAIGAKU, Okazaki-shi (JP)

(73) Assignees: Kabushiki Kaisha Kobe Seiko Sho (Kobe Steel, Ltd.), Kobe-shi (JP); TOYOTA JIDOSHA KABUSHIKI KAISHA, Toyota-shi (JP)

(21) Appl. No.: 18/869,921

(22) PCT Filed: Mar. 8, 2023
(86) PCT No.: PCT/JP2023/008873

§ 371 Date: Nov. 27, 2024

(30) Foreign Application Priority Data
Jul. 4, 2022 (JP) 2022-107707

(51) Int. Cl. H01M 50/249; B60L 50/64; B62D 25/02; H01M 50/224

(52) U.S. Cl. CPC H01M 50/249; B60L 50/64; H01M 50/224; B62D 25/025; H01M 2220/20

(57) ABSTRACT

An electric vehicle battery case includes: a frame formed in a rectangular frame shape when viewed in a vehicle vertical direction, the frame configured to define a space inside; a cross member disposed inside the frame to divide the space; and a tray having a bathtub shape, the tray configured to house a battery, the tray disposed at least partially in the space of the frame. The frame includes a pair of first framework members extending in a vehicle front-rear direction, and a pair of second framework members extending in a vehicle width direction. The cross member includes a first auxiliary member connecting the first framework members, and a second auxiliary member connecting the second framework members. The first framework members and the second framework members are mechanically joined to each other. The first auxiliary member and the second auxiliary member are mechanically joined.

### CROSS-REFERENCE TO RELATED APPLICATIONS

This is a national phase application in the United States of International Patent Application No. PCT/JP2023/008873 with an international filing date of Mar. 8, 2023, which claims priority of Japanese Patent Application No. 2022-107707 filed on Jul. 4, 2022 the contents of which are incorporated herein by reference.

### TECHNICAL FIELD

The present disclosure relates to an electric vehicle battery case and a method for manufacturing the same.

### BACKGROUND ART

An electric vehicle such as an electric car needs to mount a large capacity battery in order to secure a sufficient range, and on the other hand, is required to include a wide vehicle interior. In order to satisfy these requirements, in many electric cars, a large-capacity battery is housed in a battery case and mounted on the entire underfloor surface of the vehicle. Therefore, the electric vehicle battery case is required to have high sealing performance for preventing water from entering from a road surface or the like to prevent malfunctions of electronic components, and high collision strength is required to protect the internal battery.

For example, JP 2017-226353 discloses a battery case in which sealing performance is improved by using a tray obtained by forming a metal plate into a bathtub shape by cold press forming.

### SUMMARY OF THE INVENTION

In the battery case of JP 2017-226353, the sealing performance is improved by a bathtub-shaped tray, but in order to form a frame for housing the tray, it is necessary to join the longitudinal frame, the front beam, and the rear beam by joining means such as welding. In particular, when welding is used as the joining means, not only the manufacturing process may become complicated, but also the assembly accuracy of the frame may decrease due to welding thermal strain.

An object of the present disclosure is to provide an electric vehicle battery case and a method for manufacturing the same, in which sealing performance is improved by a bathtub-shaped tray and which is simply formed while a decrease in assembly accuracy due to welding thermal strain of a frame and a cross member that house the tray is suppressed.

A first aspect of the present disclosure provides an electric vehicle battery case including: a frame formed in a rectangular frame shape when viewed in a vehicle vertical direction, the frame configured to define a space inside; a cross member disposed inside the frame to divide the space; and a tray having a bathtub shape, the tray configured to house a battery, the tray disposed at least partially in the space of the frame. The frame includes a pair of first framework members, which is an aluminum extruded material, extending in a vehicle front-rear direction, and a pair of second framework members, which is an aluminum extruded material, extending in a vehicle width direction. The cross member includes a first auxiliary member that is an aluminum extruded material and connects the pair of first framework members, and a second auxiliary member that is an aluminum extruded material and connects the pair of second framework members. The pair of first framework members and the pair of second framework members are mechanically joined to each other. The first auxiliary member and the second auxiliary member are mechanically joined.

According to this configuration, since the pair of first framework members and the pair of second framework members are joined by a mechanical joining method, and the first auxiliary member and the second auxiliary member are joined by a mechanical joining method, complicated welding is not required. Here, the mechanical joining method is a joining method using mechanical energy, unlike a metallurgical joining method such as welding. Examples of the mechanical joining method include joining using fitting, and joining methods using bolts, nuts, rivets, and the like. Therefore, it is possible to suppress a decrease in assembly accuracy of the frame due to welding thermal strain, and to simply form the frame and the cross member. In addition, since the tray is formed in a bathtub shape, there is no joint in the tray, and high sealing performance capable of preventing water from entering from a road surface or the like can be secured. In addition, since the cross member supports the frame from the inside, high rigidity can be secured.

The pair of first framework members may include a first engagement portion. The pair of second framework members may include a second engagement portion. At least one of the first engagement portion or the second engagement portion may have a recessed shape. The pair of first framework members and the pair of second framework members may be directly joined by engagement of the first engagement portion and the second engagement portion.

According to this configuration, since the first engagement portion and the second engagement portion are engaged with each other, the pair of first framework members and the pair of second framework members are directly joined. Therefore, the frame can be simply formed. Here, the above-described engagement refers to fitting involving positional restraint structurally without requiring a separate joining means such as welding. Since accurate positioning is performed by such fitting structurally involving positional restraint, dimensional accuracy and joining accuracy can be improved.

The second engagement portion may include a recessed portion having a shape recessed upward in the vehicle vertical direction and an insertion portion constituting a part of the recessed portion and having a shape protruding downward in the vehicle vertical direction. The first engagement portion may include a recessed portion having a shape recessed downward in the vehicle vertical direction, and an insertion hole which is aligned with the insertion portion and into which the insertion portion is inserted.

According to this configuration, the engagement structure of the first engagement portion and the second engagement portion can be specifically implemented. In particular, since the recessed portions recessed in the vehicle vertical direction are fitted to each other, the positions in the horizontal direction of the pair of first framework members and the pair of second framework members are restrained. In addition, since the insertion portion is inserted into the insertion hole, it is possible to suppress release from engagement. Furthermore, since the bathtub-shaped tray is disposed with respect to the frame from above, the first engagement portion and the second engagement portion can be covered with the tray. Therefore, the position in the vehicle vertical direction is also restrained, and release from engagement can be suppressed.

The recessed portion of the first engagement portion may include a first inclined portion inclined to narrow at a first angle downward in the vehicle vertical direction as viewed in the vehicle width direction. The second engagement portion may include a second inclined portion that is aligned with the first inclined portion and is inclined to narrow at the first angle downward in the vehicle vertical direction as viewed in the vehicle width direction.

According to this configuration, since the gap between the first engagement portion and the second engagement portion decreases as they are engaged, assembly is facilitated, and furthermore, backlash after assembly can be suppressed or prevented.

The pair of first framework members may include a first hole portion provided to face the space. Both ends of the first auxiliary member may be inserted into the first hole portion.

According to this configuration, the connection of the pair of first framework members by the first auxiliary member can be specifically designed. In particular, the configuration in which the first auxiliary member is inserted into the first hole portion is simple and low-cost.

The first hole portion may include a third inclined portion inclined to narrow at a second angle downward in the vehicle vertical direction as viewed in the vehicle width direction. The first auxiliary member may include a fourth inclined portion that is aligned with the third inclined portion and is inclined to narrow at the second angle downward in the vehicle vertical direction as viewed in the vehicle width direction.

According to this configuration, since the gap between the first hole portion and the first auxiliary member decreases as they are engaged, assembly is facilitated, and furthermore, backlash after assembly can be suppressed or prevented.

The pair of second framework members may include a second hole portion provided to face the space. Both ends of the second auxiliary member may be inserted into the second hole portion.

According to this configuration, the connection of the pair of second framework members by the second auxiliary member can be specifically designed. In particular, the configuration in which the second auxiliary member is inserted into the second hole portion is simple and low-cost.

The second hole portion may include a fifth inclined portion inclined to narrow at a third angle upward in the vehicle vertical direction as viewed in the vehicle front-rear direction. The second auxiliary member may include a sixth inclined portion that is aligned with the fifth inclined portion and is inclined to narrow at the third angle upward in the vehicle vertical direction as viewed in the vehicle front-rear direction.

According to this configuration, since the gap between the second hole portion and the second auxiliary member decreases as they are engaged, assembly is facilitated, and furthermore, backlash after assembly can be suppressed or prevented.

The first auxiliary member may include a third engagement portion. The second auxiliary member may include a fourth engagement portion. At least one of the third engagement portion or the fourth engagement portion may have a recessed shape.

The first auxiliary member and the second auxiliary member may be joined by engagement of the third engagement portion and the fourth engagement portion.

According to this configuration, the rigidity of the entire frame can be improved by joining the first auxiliary member and the second auxiliary member.

The third engagement portion may include a recessed portion having a shape recessed downward in the vehicle vertical direction. The fourth engagement portion may include a recessed portion having a shape recessed upward in the vehicle vertical direction.

According to this configuration, the engagement structure of the third engagement portion and the fourth engagement portion can be specifically implemented. In particular, by fitting the recessed portions recessed in the vehicle vertical direction to each other, the horizontal positions of the first auxiliary member and the second auxiliary member are restrained. In addition, since the bathtub-shaped tray is disposed with respect to the frame from above, the third engagement portion and the fourth engagement portion can be covered with the tray. Therefore, the position in the vehicle vertical direction is also restrained, and release from engagement can be suppressed.

The third engagement portion may include a seventh inclined portion inclined to narrow at a fourth angle downward in the vehicle vertical direction as viewed in the vehicle front-rear direction. The second auxiliary member may include an eighth inclined portion that is aligned with the seventh inclined portion and is inclined to narrow at the fourth angle downward in the vehicle vertical direction as viewed in the vehicle front-rear direction.

According to this configuration, since the gap between the third engagement portion and the fourth engagement portion decreases as they are engaged, assembly is facilitated, and furthermore, backlash after assembly can be suppressed or prevented.

The fourth engagement portion may include a ninth inclined portion inclined to narrow at a fifth angle upward in the vehicle vertical direction as viewed in the vehicle width direction. The first auxiliary member may include a tenth inclined portion that is aligned with the ninth inclined portion and is inclined to narrow at the fifth angle upward in the vehicle vertical direction as viewed in the vehicle width direction.

According to this configuration, since the gap between the third engagement portion and the fourth engagement portion decreases as they are engaged, assembly is facilitated, and furthermore, backlash after assembly can be suppressed or prevented.

The pair of first framework members may have a first top surface that is positioned at an uppermost position in the vehicle vertical direction and extends in a horizontal direction. The pair of second framework members may have a second top surface that is positioned at an uppermost position in the vehicle vertical direction and extends in a horizontal direction. The first top surface and the second top surface may be flush with each other.

According to this configuration, the generation of a gap between the frame and the tray can be suppressed or prevented. Therefore, the sealing performance can be improved.

The pair of first framework members may have a tubular shape whose inside is partitioned in the vehicle vertical direction by a first partition wall extending in a horizontal direction. The pair of second framework members may have a tubular shape whose inside is partitioned in the vehicle vertical direction by a second partition wall extending in a horizontal direction. The first partition wall and the second partition wall may be disposed at an identical height in the vehicle vertical direction.

According to this configuration, when a collision load in the horizontal direction is applied to the frame, the collision load can be transmitted to the entire frame through the first partition wall and the second partition wall. Therefore, the collision load can be absorbed by the entire frame, and the crashworthiness can be improved.

A joining member for joining the pair of first framework members and the pair of second framework members may be further included. The pair of first framework members and the pair of second framework members may be indirectly joined through the joining member by joining the pair of first framework members and the joining member by a mechanical joining method and joining the pair of second framework members and the joining member by a mechanical joining method.

According to this configuration, without complicated processing being performed on the pair of first framework members and the pair of second framework members, which are extruded materials, the pair of first framework members and the pair of second framework members can be joined.

The tray may be in pressure contact with the frame.

According to this configuration, the frame and the tray can be easily integrated without requiring welding.

A negative angle portion in which a negative angle directed at least partially inward in a horizontal direction from a bottom wall of the tray upward in the vehicle vertical direction is formed may be provided.

According to this configuration, the negative angle portion is caught by the frame even when an upward force is applied to the tray, so that the tray can be prevented from being detached from the frame. That is, the pressure contact between the tray and the frame can be prevented from being released.

A second aspect of the present disclosure provides a method for manufacturing an electric vehicle battery case, the method including: preparing a flat plate-shaped member to be formed, a pair of first framework members that is an aluminum extruded material, a pair of second framework members that is an aluminum extruded material, a first auxiliary member that is an aluminum extruded material, and a second auxiliary member that is an aluminum extruded material; disposing the pair of first framework members so as to extend in a vehicle front-rear direction; disposing the pair of second framework members so as to extend in a vehicle width direction; mechanically joining the pair of first framework members and the pair of second framework members, thereby forming a frame that has a rectangular frame shape when viewed from a vehicle vertical direction and defines a space inside, and mechanically joining the first auxiliary member that connects the pair of first framework members and the second auxiliary member that connects the pair of second framework members so as to divide the space, thereby forming a cross member; superposing and disposing the member to be formed on the frame and the cross member; and applying pressure to the member to be formed from a side opposite to that of the frame and the cross member, pressing the member to be formed against the frame and the cross member to bulge the member to be formed in the space, thereby deforming the member to be formed into a tray having a bathtub shape and bringing the member to be formed into pressure contact with the frame and the cross member.

According to this method, since the pair of first framework members and the pair of second framework members are joined by a mechanical joining method, and the first auxiliary member and the second auxiliary member are joined by a mechanical joining method, complicated welding is not required. Here, the mechanical joining method is a joining method using mechanical energy, unlike a metallurgical joining method such as welding. Examples of the mechanical joining method include joining methods using bolts, nuts, rivets, and the like. Therefore, it is possible to suppress a decrease in assembly accuracy of the frame due to welding thermal strain, and to simply form the frame and the cross member. In addition, since the tray is formed in a bathtub shape, there is no joint in the tray, and high sealing performance capable of preventing water from entering from a road surface or the like can be secured. In addition, since the cross member supports the frame from the inside, high rigidity can be secured.

The method for manufacturing an electric vehicle battery case may further include: further preparing an elastic body into which liquid is to be injected, disposing the elastic body so as to be in contact with the member to be formed, and injecting pressurized liquid into the elastic body, thereby applying pressure to the member to be formed from a side opposite to that of the frame and the cross member, pressing the member to be formed against the frame and the cross member to bulge the member to be formed in the space, thereby deforming the member to be formed into a tray having a bathtub shape and bringing the member to be formed into pressure contact with the frame.

According to this method, it is possible to easily bulge and deform the member to be formed to such a complex shape in which the cross member is disposed. In other words, the bulging amount of the member to be formed can be increased, and the tray can be firmly brought into pressure contact with the frame and the cross member.

The method for manufacturing an electric vehicle battery case may further include performing preforming using a die before performing deforming and pressure contact.

According to this configuration, the step of deforming the tray in accordance with the shapes of the frame and the cross member is performed at least twice. Therefore, as compared with the case where the member to be formed is deformed at one time, distortion is less likely to occur, and formability can be improved.

According to the present disclosure, in an electric vehicle battery case and a method for manufacturing the same, the sealing performance can be improved by the bathtub-shaped tray, and the frame housing the tray can be easily formed while suppressing the decrease in assembly accuracy due to the welding thermal strain.

### BRIEF DESCRIPTION OF THE DRAWINGS

FIG. 1 is a side view of an electric car mounting an electric vehicle battery case according to a first embodiment of the present disclosure;

FIG. 2 is a schematic cross-sectional view of a battery case;

FIG. 3 is a perspective view of a battery case;

FIG. 4 is an exploded perspective view of a battery case;

FIG. 5 is an exploded perspective view of a frame;

FIG. 6 is an exploded perspective view of a first framework member and a first auxiliary member;

FIG. 7 is a cross-sectional view taken along line VII-VII in FIG. 4;

FIG. 8 is an exploded perspective view of a second framework member and a second auxiliary member;

FIG. 9 is a cross-sectional view taken along line IX-IX in FIG. 4;

FIG. 10 is a cross-sectional view taken along line X-X in FIG. 4;

FIG. 11 is a cross-sectional view taken along line XI-XI in FIG. 4;

FIG. 12 is a perspective view of a member to be formed, a first framework member, and a second framework member;

FIG. 13 is a first cross-sectional view showing a method for manufacturing a battery case;

FIG. 14 is a second cross-sectional view showing a method for manufacturing a battery case.

FIG. 15 is a third cross-sectional view showing a method for manufacturing a battery case;

FIG. 16 is a cross-sectional view showing preforming;

FIG. 17 is an exploded perspective view of a part of a battery case according to a second embodiment of the present disclosure; and

FIG. 18 is an exploded perspective view of a part of a battery case in a modification of the second embodiment.

### DETAILED DESCRIPTION

Hereinafter, embodiments of the present disclosure will be described with reference to the accompanying drawings.

### First Embodiment

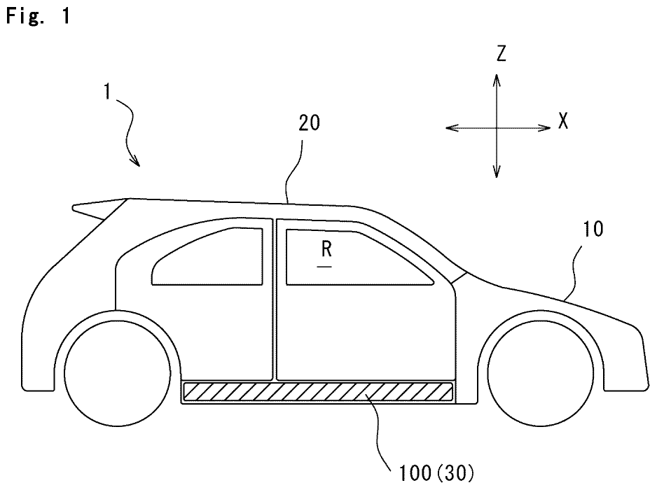

Referring to FIG. 1, an electric vehicle 1 is a vehicle that travels by driving a motor (not shown) by electric power supplied from a battery 30. For example, the electric vehicle 1 may be an electric car, a plug-in hybrid vehicle, or the like. The type of the vehicle is not particularly limited, and may be a passenger car, a truck, a maintenance vehicle, other mobility, or the like. Hereinafter, a case of a passenger car type electric car as the electric vehicle 1 will be taken as an example to be described.

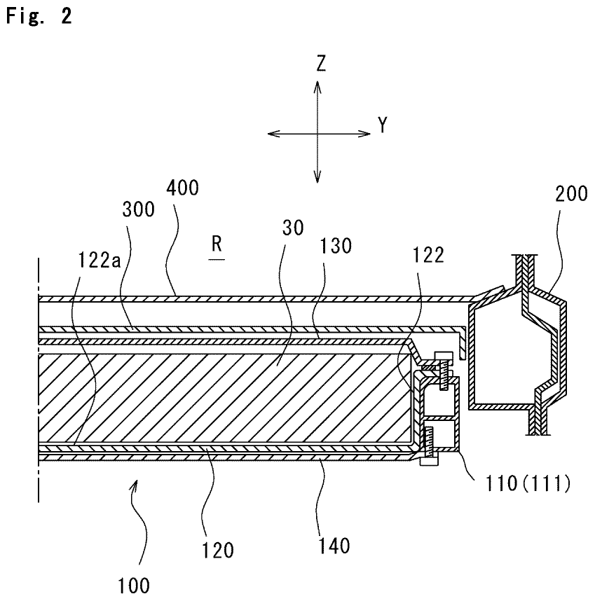

The electric vehicle 1 mounts a motor, a high-voltage apparatus, and the like (not shown) in the vehicle body front portion 10. In addition, the electric vehicle 1 mounts an electric vehicle battery case 100 (hereinafter, also simply referred to as a battery case 100) in which a battery 30 is housed on substantially the entire underfloor surface of the vehicle interior R of the vehicle body central portion 20. It should be noted that in FIG. 1, the front-rear direction of the electric vehicle 1 is represented by the X direction, and the vertical direction is represented by the Z direction. The same notation also applies to the following drawings, and the vehicle width direction is represented by the Y direction in FIG. 2 and subsequent figures.

Referring to FIG. 2, the battery case 100 is disposed inside the rocker member 200 in the vehicle width direction. The rocker member 200 extends in the vehicle front-rear direction at both lower ends in the vehicle width direction of the electric vehicle 1 (see FIG. 1). The rocker member 200 is formed by bonding a plurality of metal plates, and has a function of protecting the vehicle interior R and the battery case 100 against impact from the side of the electric vehicle 1.

Referring also to FIGS. 2 to 4, the battery case 100 includes a frame 110 defining a through hole TH, a tray 120 having a bathtub shape, a top cover 130 (see FIG. 2) and an undercover 140 (see FIG. 2) arranged so as to sandwich them from above and below. Here, the through hole TH is an example of a space in the present disclosure.

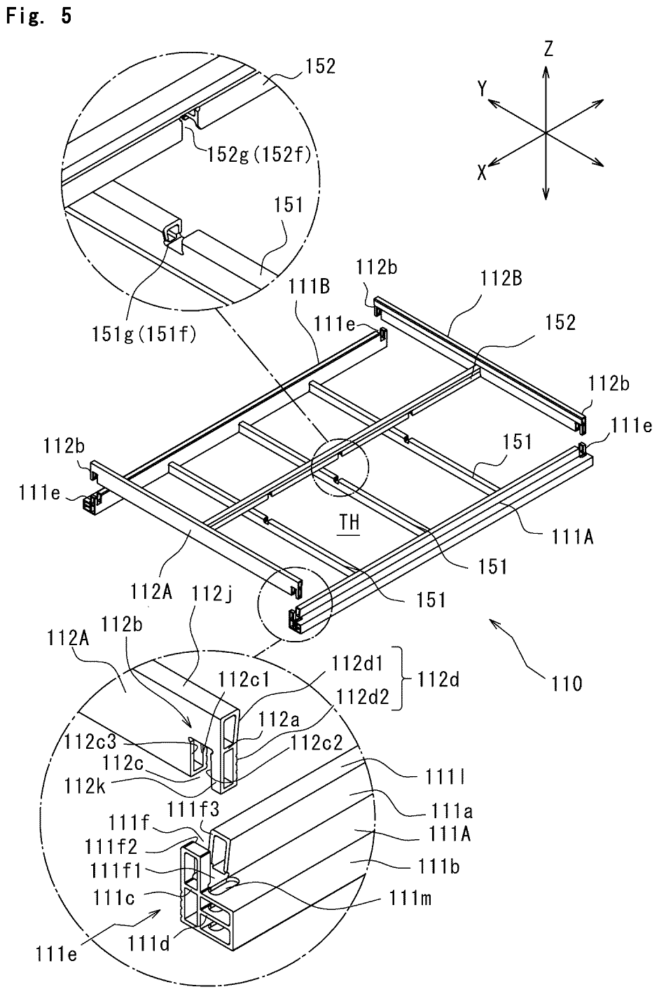

Referring also to FIG. 5, the frame 110 is a member forming the framework of the battery case 100. The frame 110 is formed in a rectangular frame shape when viewed from the vehicle vertical direction by joining a pair of first framework members 111A and 111B and a pair of second framework members 112A and 112B, and defines the through hole TH inside. Hereinafter, the inner side of the frame 110 refers to the center side of the rectangular frame shape, and the outer side refers to the opposite side. In addition, hereinafter, although the first framework member 111A and the second framework member 112A will be mainly described, the first framework member 111B and the second framework member 112B also have the same configuration.

Referring to FIG. 5, the first framework member 111A is an aluminum extruded material linearly extending in the vehicle front-rear direction. The first framework member 111A includes a first framework member main body 111a and a first framework member reinforcing portion 111b disposed outside the first framework member main body 111a. The first framework member main body 111a has a hollow shape (tubular shape) and has a top surface (first top surface) 111l that is positioned at the uppermost position in the vehicle vertical direction and extends in the horizontal direction. The inside of the first framework member main body 111a is partitioned in the vehicle vertical direction by a partition wall (first partition wall) 111c extending in the horizontal direction (the vehicle width direction and the vehicle front-rear direction). In addition, the first framework member reinforcing portion 111b has a hollow shape. Similarly, the inside of the first framework member reinforcing portion 111b is partitioned in the vehicle vertical direction by a partition wall 111d extending in the horizontal direction.

In addition, the first framework member 111A has first engagement portions 111e at both end portions in the vehicle front-rear direction. The first engagement portion 111e has a recessed shape. Specifically, the first engagement portion 111e includes a recessed portion 111f having a shape recessed downward in the vehicle vertical direction and an insertion hole 111m provided in the first framework member reinforcing portion 111b so as to be aligned with an insertion portion 112k to be described below and into which the insertion portion 112k is inserted. The recessed portion 111f includes a bottom surface 111f1 and two side surfaces 111f2 and 111f3. The bottom surface 111f1 includes the partition wall 111c. One side surface 111f2 is provided perpendicular to the bottom surface 111f1 (that is, along the vertical direction), and the other side surface (first inclined portion) 111f3 is provided to be inclined in accordance with the inclination of an inclined surface 112d1 of the second framework member 112A described below.

The second framework member 112A is an aluminum extruded material linearly extending in the vehicle width direction. The second framework member 112A has a hollow shape (tubular shape) and has a top surface (second top surface) 112j that is positioned at the uppermost position in the vehicle vertical direction and extends in the horizontal direction. The inside of the second framework member 112A is partitioned in the vehicle vertical direction by a partition wall (second partition wall) 112a. The second framework member 112A includes an inner surface 112d on the inside in the vehicle front-rear direction. The inner surface 112d includes an inclined surface (second inclined portion) 112d1 above the partition wall 112a and a vertical surface 112d2 below the partition wall 112a. The inclined surface 112d1 is inclined from the vertical direction in accordance with the other side surface 111f3 as described above, but the vertical surface 112d2 extends along the vertical direction (vehicle vertical direction).

The second framework member 112A includes second engagement portions 112b at both end portions. The second engagement portion 112b has a recessed shape. Specifically, the second engagement portion 112b includes a recessed portion 112c having a shape recessed upward in the vehicle vertical direction, and an insertion portion 112k constituting a part of the recessed portion 112c and having a shape protruding downward in the vehicle vertical direction. The recessed portion 112c includes a top surface 112c1 and two side surfaces 112c2 and 112c3. The top surface 112c1 of the recessed portion 112c includes the partition wall 112a. The two side surfaces 112c2 and 112c3 of the recessed portion 112c are provided perpendicular to the top surface 112c1 (that is, along the vertical direction).

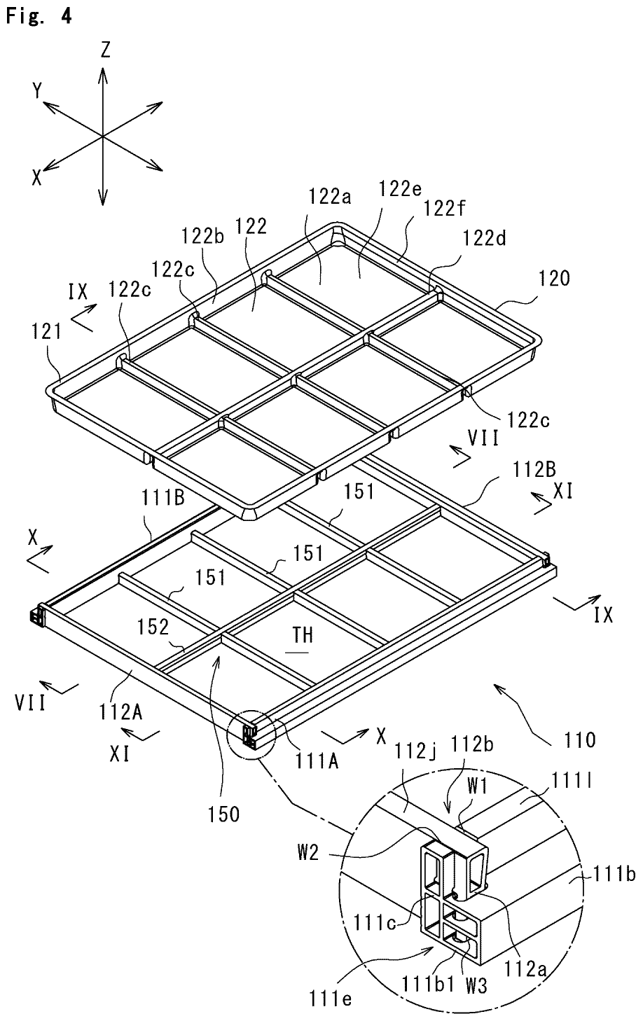

The first engagement portion 111e and the second engagement portion 112b have shapes to be engaged with each other. Here, the engagement is one of mechanical joining methods, and refers to fitting involving positional restraint structurally without requiring a separate joining means such as welding. Here, the mechanical joining method is a joining method using mechanical energy, unlike a metallurgical joining method such as welding. Although different from the present embodiment, the mechanical joining method may include, for example, a joining method using a bolt and a nut, a rivet, and the like. In the present embodiment, the recessed portion 111f of the first engagement portion 111e and the recessed portion 112c of the second engagement portion 112b are engaged, whereby the first framework member 111A and the second framework member 112A are directly joined. It should be noted that the first engagement portion 111e and the second engagement portion 112b may be welded as long as they are in a degree where welding thermal strain does not occur. For example, welding may be performed at welding portions W1, W2, and W3 shown in FIG. 4. The welding portions W1 and W2 are portions where the top surface 111l and the top surface 112j are in contact with each other. The welding portion W3 is a portion where the insertion portion 112k and the bottom wall 111b1 of the first framework member reinforcing portion 111b are in contact with each other.

Referring to FIG. 4, when the first engagement portion 111e and the second engagement portion 112b are engaged with each other, the top surface 111l and the top surface 112j are flush with each other. In addition, the partition wall 111c and the partition wall 112a are disposed at the identical height in the vehicle vertical direction.

It should be noted that in the present embodiment, the frame 110 defining the through hole TH will be described as an example, but the shape of the frame 110 is not limited to the through shape. For example, the frame 110 may have a recessed shape instead of the through shape, that is, may have a bottom wall.

In addition, in the present embodiment, a structure is exemplified in which both the first engagement portion 111e and the second engagement portion 112b have a shape recessed in the vehicle vertical direction, but the first engagement portion 111e and the second engagement portion 112b are not limited to this shape, and may have any shape capable of joining the first framework member 111A and the second framework member 112A. For example, a structure may be used in which only one of the first engagement portion 111e or the second engagement portion 112b has a recessed shape. The recessed shape is not limited to a shape recessed in the vehicle vertical direction, and may be a shape recessed in another direction. In addition, an engagement structure other than the recessed shape may be adopted.

Referring to FIG. 4, in the present embodiment, a cross member 150 is disposed inside the frame 110 so as to divide the through hole TH. The cross member 150 includes three first auxiliary members 151 connecting the pair of first framework members 111A and 111B and one second auxiliary member 152 connecting the pair of second framework members 112A and 112B. As will be described in detail below, the first auxiliary member 151 and the second auxiliary member 152 are engaged at positions intersecting each other.

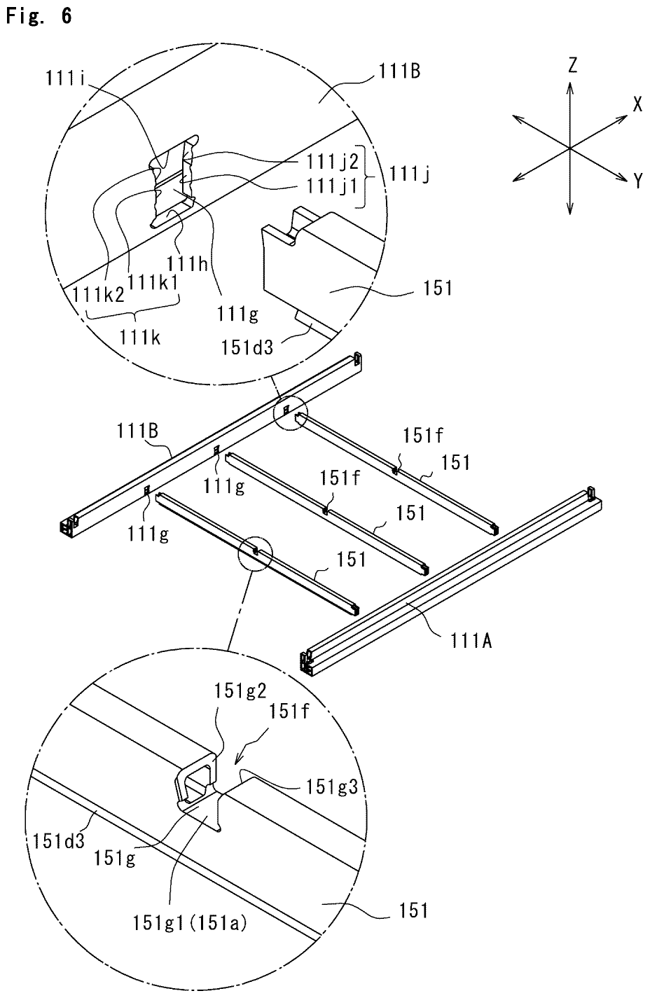

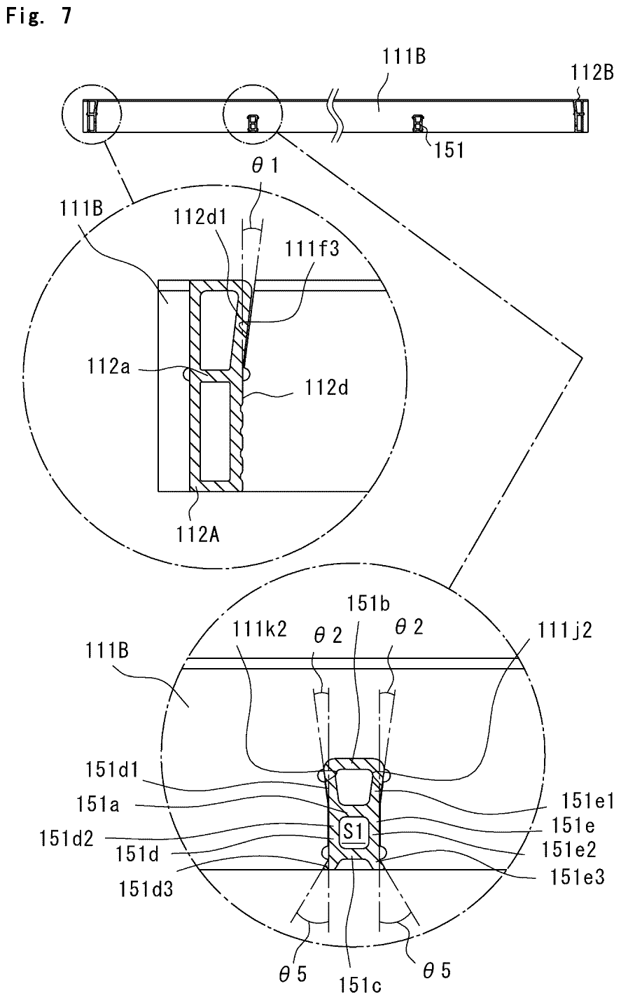

Referring to FIGS. 6 and 7, the first framework member 111B includes a first hole portion 111g provided substantially at the center in the vehicle front-rear direction so as to face the inside (through hole TH). It should be noted that in FIGS. 6 and 7, the description will be made using the first framework member 111B, but the same configuration is applied to the first framework member 111A. The first hole portion 111g is defined by a bottom surface 111h, a top surface 111i facing the bottom surface 111h, and two side surfaces 111j and 111k connecting the bottom surface 111h and the top surface 111i. The side surface 111j has a lower side surface 111j1 provided vertically (that is, along the vertical direction) and an upper side surface 111j2 inclined at an angle (second angle) θ2 from the vertical direction in a cross-section perpendicular to the vehicle width direction. In addition, the side surface 111k has a lower side surface 111k1 provided vertically (that is, along the vertical direction) and an upper side surface 111k2 inclined at an angle (second angle) θ2 from the vertical direction in a cross-section perpendicular to the vehicle width direction. That is, the upper side surface 111j2, 111k2 is inclined so as to narrow at an angle θ2 downward in the vehicle vertical direction when viewed from the vehicle width direction. The upper side surfaces 111j2 and 111k2 form a third inclined portion. For example, the angle θ2 may be 1 degree or more and 10 degrees or less.

The first auxiliary member 151 is an aluminum extruded material linearly extending in the vehicle width direction. The first auxiliary member 151 has a hollow shape in a cross-section perpendicular to the vehicle width direction. The inside of the first auxiliary member 151 is partitioned in the vehicle vertical direction by a partition wall 151a. The first auxiliary member 151 includes a top wall 151b positioned at an upper portion in the vehicle vertical direction, a bottom wall 151c facing the top wall 151b, and side walls 151d and 151e connecting respective ends of the top wall 151b and the bottom wall 151c. In the present embodiment, the side wall 151d, 151e includes an upper side wall (fourth inclined portion) 151d1, 151e1, a middle side wall 151d2. 151e2, and a lower side wall (tenth inclined portion) 151d3, 151e3. The middle side wall 151d2, 151e2 is provided vertically (that is, along the vertical direction) in a cross-section perpendicular to the vehicle width direction. The upper side wall 151d1, 151e1 is inclined by an angle θ2 from the vertical direction. In other words, the upper side wall 151d1, 151e1 is inclined so as to narrow at the angle θ2 downward in the vehicle vertical direction as viewed in the vehicle width direction. In addition, the lower side wall 151d3, 151e3 is inclined by an angle θ5 from the vertical direction. In other words, the lower side wall 151d3, 151e3 is inclined so as to narrow at the angle θ5 upward in the vehicle vertical direction as viewed in the vehicle width direction. For example, the angle θ5 may be 1 degree or more and 10 degrees or less.

The first auxiliary member 151 is longer than the distance between the pair of first framework members 111A and 111B, and both ends of the first auxiliary member 151 are inserted into the first hole portions 111g of the pair of first framework members 111A and 111B. At this time, the upper side surfaces 111k2 and 111j2 and the upper side walls 151d1 and 151e1 are respectively in surface contact with each other. In other words, the upper side walls 151d1 and 151e1 are respectively aligned with the upper side surfaces 111k2 and 111j2.

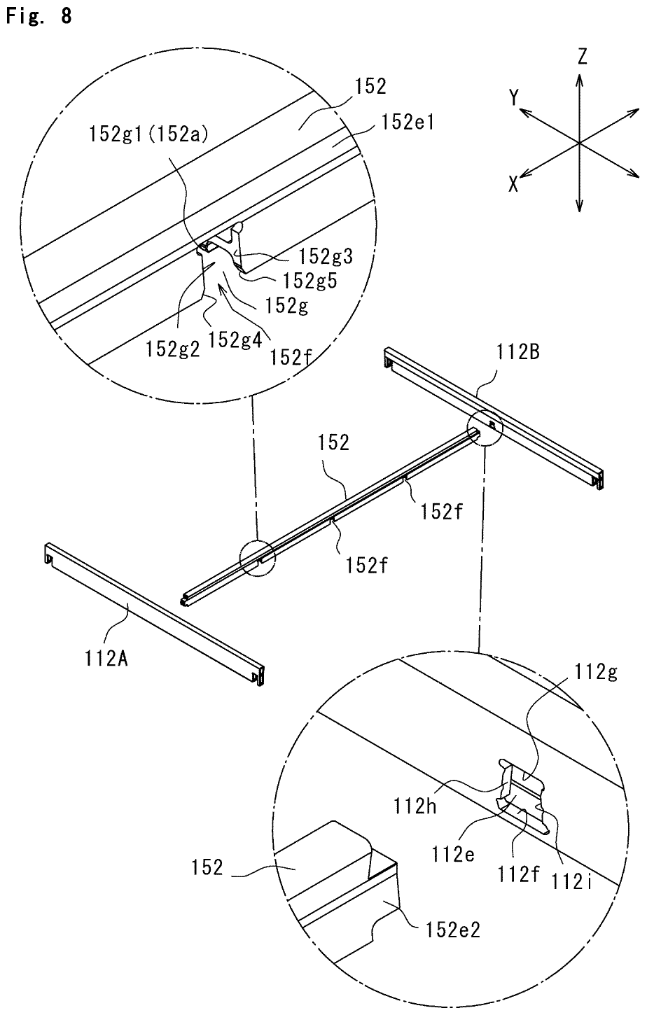

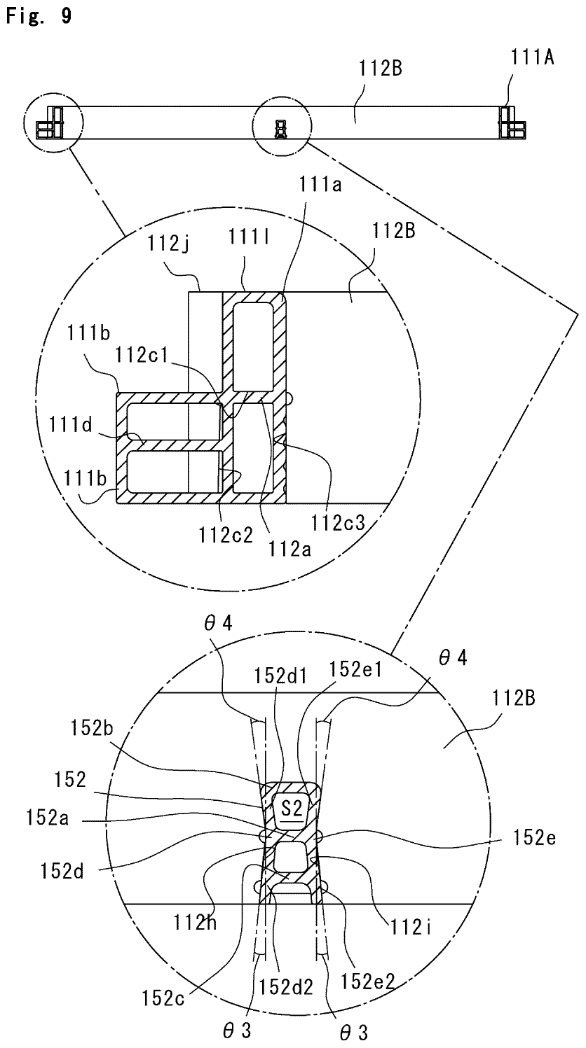

Referring to FIGS. 8 and 9, the second framework member 112B includes a second hole portion 112e provided substantially at the center in the vehicle width direction so as to face the inside (through hole TH). It should be noted that in FIG. 8, the description will be made using the second framework member 112B, but the same configuration is applied to the second framework member 112A. The second hole portion 112e is defined by a bottom surface 112f, a top surface 112g facing the bottom surface 112f, and two side surfaces 112h and 112i connecting the bottom surface 112f and the top surface 112g. The side surface 112h is inclined by an angle (third angle) θ3 from the vertical direction in a cross-section perpendicular to the vehicle front-rear direction. In addition, the side surface 112i is inclined by an angle (third angle) θ3 from the vertical direction in a cross-section perpendicular to the vehicle front-rear direction. That is, the lower side surface 112h, 112i is inclined so as to narrow at an angle θ3 upward in the vehicle vertical direction when viewed from the vehicle width direction. The lower side surfaces 112h and 112i form a fifth inclined portion. For example, the angle θ3 may be 1 degree or more and 10 degrees or less.

The second auxiliary member 152 is an aluminum extruded material linearly extending in the vehicle front-rear direction. The second auxiliary member 152 has a hollow shape in a cross-section perpendicular to the vehicle front-rear direction. The inside of the second auxiliary member 152 is partitioned in the vehicle vertical direction by a partition wall 152a. The second auxiliary member 152 includes a top wall 152b positioned at an upper portion in the vehicle vertical direction, a bottom wall 152c facing the top wall 152b, and side walls 152d and 152e connecting respective ends of the top wall 152b and the bottom wall 152c. In the present embodiment, the side wall 152d, 152e includes an upper side wall (eighth inclined portion) 152d1, 152e1 and a lower side wall (sixth inclined portion) 152d2, 152e2. The lower side wall 152d2, 152e2 is inclined by an angle θ3 from the vertical direction in a cross-section perpendicular to the vehicle front-rear direction. In other words, the lower side wall 152d2, 152e2 is inclined so as to narrow at the angle θ3 upward in the vehicle vertical direction as viewed in the vehicle front-rear direction. In addition, the upper side wall 152d1, 152e1 is inclined by an angle θ4 from the vertical direction in a cross-section perpendicular to the vehicle front-rear direction. In other words, the upper side wall 152d1, 152e1 is inclined so as to narrow at the angle θ4 downward in the vehicle vertical direction as viewed in the vehicle front-rear direction. For example, the angle θ4 may be 1 degree or more and 10 degrees or less.

The second auxiliary member 152 is longer than the distance between the pair of second framework members 112A and 112B, and both ends of the second auxiliary member 152 are inserted into the second hole portions 112e of the pair of second framework members 112A and 112B. At this time, the lower side surfaces 112h and 112i and the lower side walls 152d2 and 152e2 are respectively in surface contact with each other. In other words, the lower side walls 152d2 and 152e2 are respectively aligned with the lower side surfaces 112h and 112i.

Referring to FIG. 7, the side surface 111f3 of the first engagement portion 111e is inclined by an angle (first angle) θ1 from the vertical direction. In other words, the side surface 111f3 is inclined so as to narrow at the angle θ1 downward in the vehicle vertical direction as viewed in the vehicle width direction. For example, the angle θ1 may be 1 degree or more and 10 degrees or less. In addition, the inclined surface 112d1 is inclined by an angle θ1 from the vertical direction so as to narrow the through hole TH as it goes upward in the vehicle vertical direction in a cross-section perpendicular to the vehicle width direction. In other words, the inclined surface 112d1 is inclined so as to narrow at the angle θ1 downward in the vehicle vertical direction as viewed in the vehicle width direction. When the first engagement portion 111e and the second engagement portion 112b are engaged with each other, the side surface 111f3 of the first engagement portion 111e and the inclined surface 112d1 of the second framework member 112A are in surface contact with each other. In other words, the second engagement portion 112b includes the inclined surface 112d1 aligned with the side surface 111f3.

Referring to FIGS. 6 and 10, the first auxiliary member 151 has a third engagement portion 151f at a substantially central portion in the vehicle width direction (that is, a portion where the first auxiliary member 151 and the second auxiliary member 152 intersect). In other words, the third engagement portion 151f is aligned with the second auxiliary member 152 in the vehicle width direction. The third engagement portion 151f has a recessed shape. Specifically, the third engagement portion 151f includes a recessed portion 151g having a shape recessed downward in the vehicle vertical direction. The recessed portion 151g includes a bottom surface 151g1 and side surfaces (seventh inclined portions) 151g2 and 151g3. The bottom surface 151g1 includes the partition wall 151a. That is, the first auxiliary member 151 has a closed space S1 (see FIG. 7) below the recessed portion 151g in the vehicle vertical direction in a cross-section perpendicular to the vehicle width direction. The side surface 151g2, 151g3 is inclined by an angle (fourth angle) θ4 from the vertical direction in a cross-section perpendicular to the vehicle front-rear direction. In other words, the side surface 151g2, 151g3 is inclined so as to narrow at the angle θ4 downward in the vehicle vertical direction as viewed in the vehicle front-rear direction.

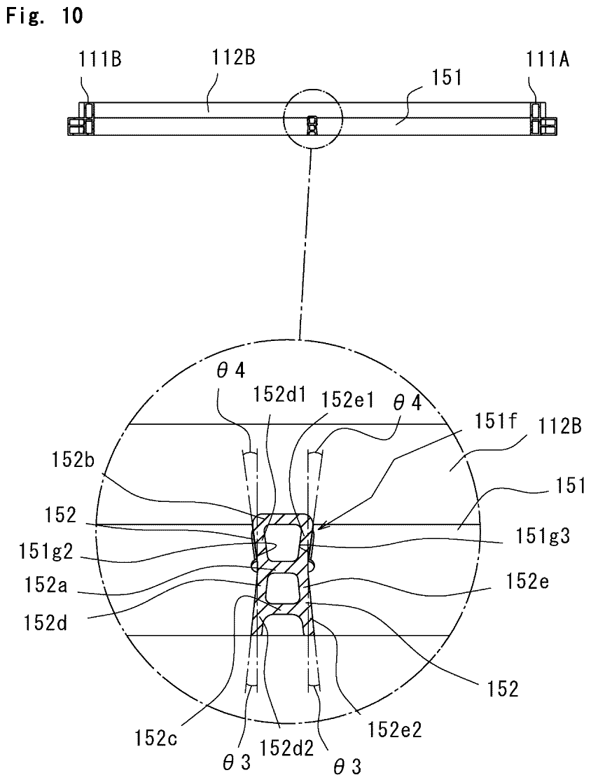

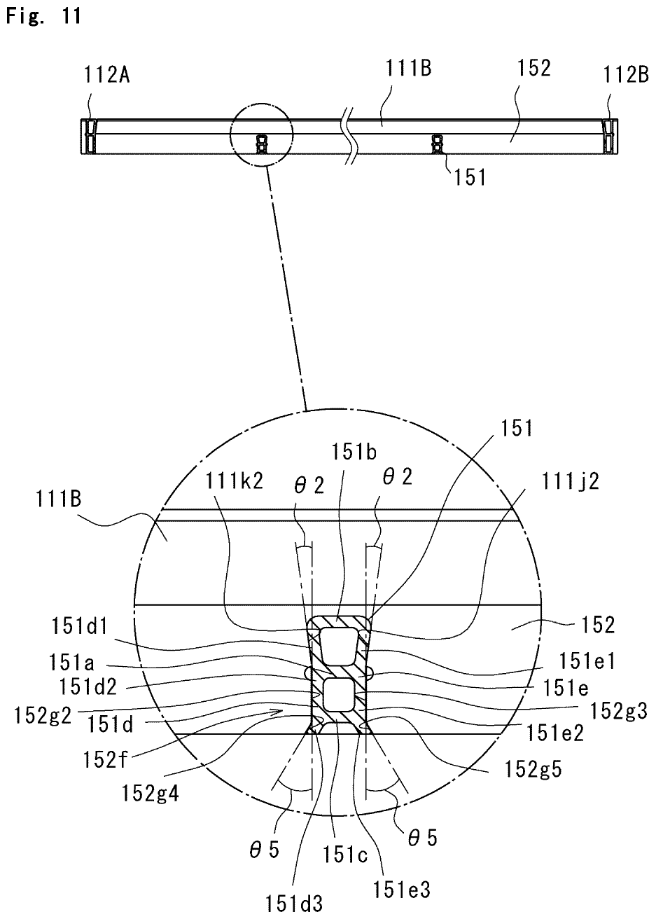

Referring to FIGS. 8 and 11, the second auxiliary member 152 has a fourth engagement portion 152f at a portion where the first auxiliary member 151 and the second auxiliary member 152 intersect. In other words, the fourth engagement portion 152f is aligned with the first auxiliary member 151 in the vehicle front-rear direction. The fourth engagement portion 152f has a recessed shape. Specifically, the fourth engagement portion 152f includes a recessed portion 152g having a shape recessed upward in the vehicle vertical direction. The recessed portion 152g includes a top surface 152g1, upper side surfaces 152g2 and 152g3, and lower side surfaces (ninth inclined portions) 152g4 and 152g5. The top surface 152g1 includes the partition wall 152a. That is, the second auxiliary member 152 has a closed space S2 (see FIG. 9) above the recessed portion 152g in the vehicle vertical direction in a cross-section perpendicular to the vehicle front-rear direction. The upper side surface 152g2, 152g3 is provided perpendicular to the top surface 152g1 (that is, along the vertical direction). The lower side surface 152g4, 152g5 is continuous from the upper side surface 152g2, 152g3 and is inclined by an angle (fifth angle) θ5 from the vertical direction in a cross-section perpendicular to the vehicle width direction. In other words, the lower side surface 152g4, 152g5 is inclined so as to narrow at the angle θ5 upward in the vehicle vertical direction as viewed in the vehicle width direction.

Referring to FIGS. 5, 10, and 11, the third engagement portion 151f and the fourth engagement portion 152f have shapes to be engaged with each other. In the present embodiment, the recessed portion 151g of the third engagement portion 151f and the recessed portion 152g of the fourth engagement portion 152f are engaged, whereby the first auxiliary member 151 and the second auxiliary member 152 are directly joined. Specifically, the side surface 151g2, 151g3 of the third engagement portion 151f and the upper side wall 152d1, 152e1 of the second auxiliary member 152 are in surface contact with each other (see FIG. 10). That is, the side surface 151g2, 151g3 of the third engagement portion 151f and the upper side wall 152d1, 152e1 of the second auxiliary member 152 are aligned with each other. In addition, the lower side surface 152g4, 152g5 of the fourth engagement portion 152f and the lower side wall 151d3, 151e3 of the first auxiliary member 151 are in surface contact with each other (see FIG. 11). That is, the lower side surface 152g4, 152g5 of the fourth engagement portion 152f and the lower side wall 151d3, 151e3 of the first auxiliary member 151 are aligned with each other. It should be noted that only a portion aligned with the side surface 151g2, 151g3 of the third engagement portion 151f in the second auxiliary member 152 may be inclined at the angle θ4. In addition, only a portion aligned with the lower side surface 152g4, 152g5 of the fourth engagement portion 152f in the first auxiliary member 151 may be inclined at the angle θ4.

In addition, in the present embodiment, a structure is exemplified in which both the third engagement portion 151f and the fourth engagement portion 152f have a shape recessed in the vehicle vertical direction, but the third engagement portion 151f and the fourth engagement portion 152f are not limited to this shape, and may have any shape capable of joining the first auxiliary member 151 and the second auxiliary member 152. For example, a structure may be used in which only one of the third engagement portion 151f or the fourth engagement portion 152f has a recessed shape. The recessed shape is not limited to a shape recessed in the vehicle vertical direction, and may be a shape recessed in another direction. In addition, an engagement structure other than the recessed shape may be adopted.

Referring to FIG. 4, the tray 120 is a bathtub-shaped member that houses the battery 30 (see FIG. 2). The tray 120 is made of, for example, a plate material made of an aluminum alloy. The tray 120 includes a flange 121 extending in a horizontal direction (X-Y direction) at an outer edge portion, and a housing portion 122 having a recessed shape continuously with the flange 121. The housing portion 122 is a portion that houses the battery 30 and is partially disposed in the through hole TH of the frame 110. The housing portion 122 has a bottom wall 122a constituting a bottom surface, and a peripheral wall 122b provided around the bottom wall 122a and defining an opening 122e on the opposite side from the bottom wall 122a. As will be described in detail below, the peripheral wall 122b brought into pressure contact with the frame 110.

A projecting portion 122c having a shape complementary to the first auxiliary member 151 and a projecting portion 122d having a shape complementary to the second auxiliary member 152 are formed on the bottom wall 122a of the housing portion 122. The projecting portion 122c is a portion where the bottom wall 122a partially projects upward and extends in the vehicle width direction. The projecting portion 122d is a portion where the bottom wall 122a partially projects upward and extends in the vehicle front-rear direction. Although described in detail below, the projecting portion 122c is in pressure contact with the first auxiliary member 151, and the projecting portion 122d is in pressure contact with the second auxiliary member 152.

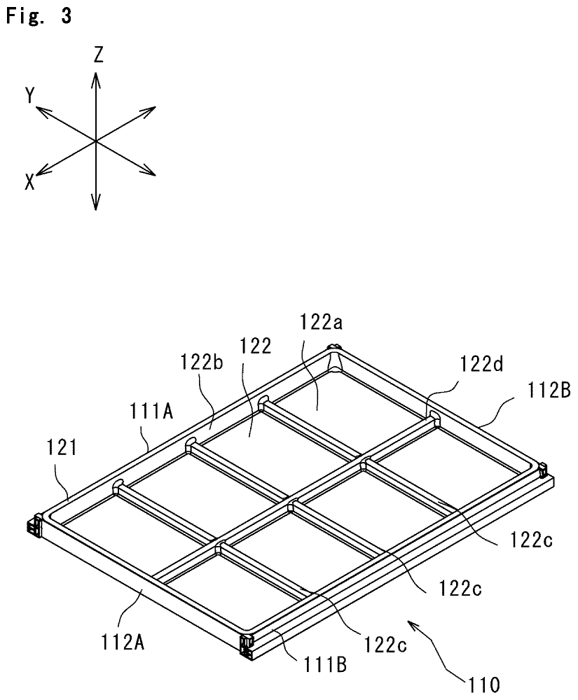

Referring to FIG. 3 again, in a state where the tray 120 and the frame 110 are combined, the flange 121 of the tray 120 is placed on the top surface 111l, 112j (see FIG. 4) of the frame 110, and the housing portion 122 of the tray 120 is disposed in the through hole TH of the frame 110. At this time, the projecting portion 122c, 122d is disposed so as to partially cover the cross member 150. Although an exploded view is virtually shown in FIG. 4 for the sake of illustration, the tray 120 is integrated in a combined state as shown in FIG. 3 by the projecting portion 122c, 122d being brought into pressure contact with the cross member 150.

Referring to FIG. 2 again, the battery 30 is disposed on the housing portion 122 of the tray 120. Hermetically sealing the housing portion 122 with the top cover 130 from above the battery 30 houses the battery 30 in the battery case 100. The hermetic sealing structure prevents water from entering the battery case 100 from the outside. In particular, since the tray 120 is formed in a bathtub shape, there is no joint in the tray 120, and high sealing performance capable of preventing water from entering from a road surface or the like can be secured. In addition, a safety valve for pressure adjustment inside the battery case 100 may be provided.

In the example in FIG. 2, the top cover 130 and the tray 120 are jointly fastened and fixed to the frame 110 by screws. Above the top cover 130, a floor panel 300 constituting a floor surface of the vehicle interior R and a floor cross member 400 extending in the vehicle width direction in the vehicle interior R are disposed. In addition, an undercover 140 is disposed below the tray 120. The undercover 140 is screwed to each of the frame 110 and the cross member 150 to support the tray 120 from below.

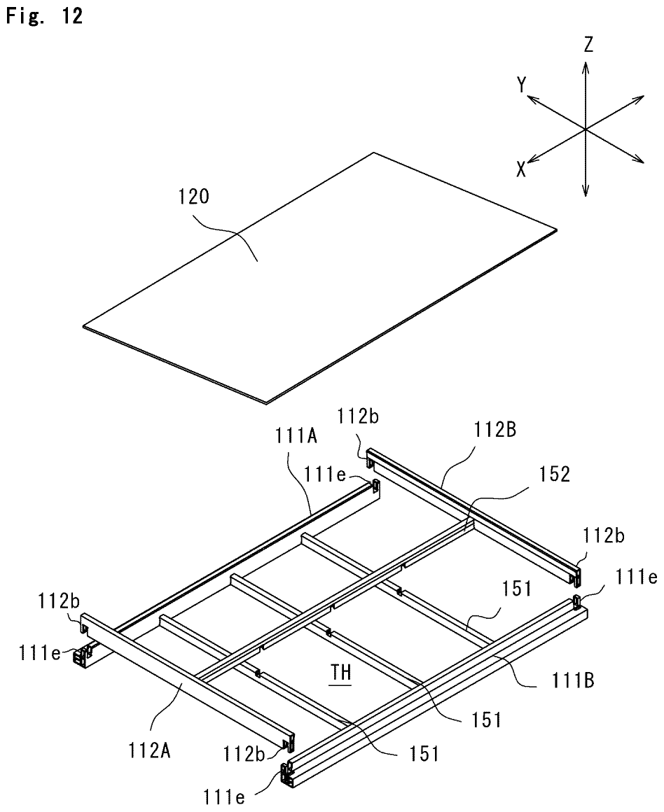

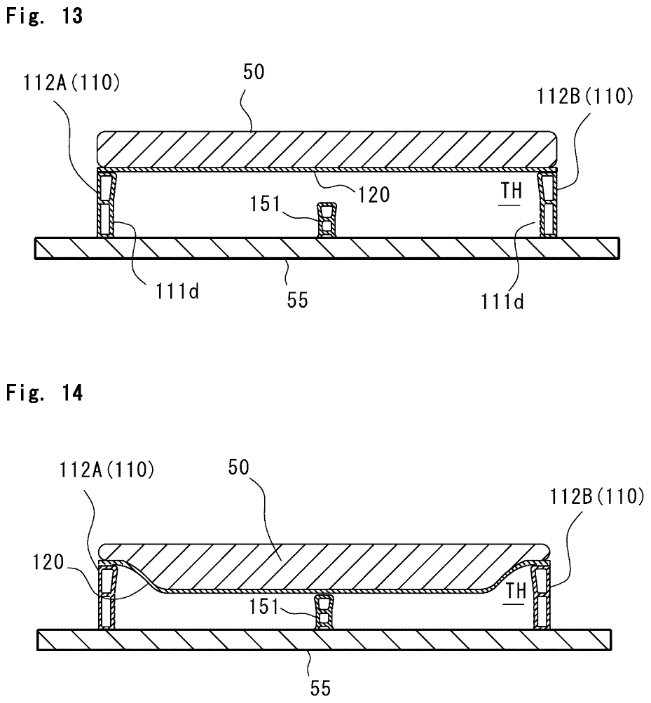

A method for manufacturing the battery case 100 having the above configuration will be described with reference to FIGS. 12 to 15. FIGS. 13 to 15 show cross-sections perpendicular to the vehicle width direction. In FIGS. 13 to 15, only one first auxiliary member 151 is shown for clarity of illustration.

Referring to FIG. 12, a flat plate-shaped member to be formed 120, a pair of first framework members 111A and 111B, a pair of second framework members 112A and 112B, a first auxiliary member 151, and a second auxiliary member 152 are prepared. Then, the pair of first framework members 111A and 111B is disposed so as to extend in the vehicle front-rear direction, and both ends of the first auxiliary member 151 are inserted into the first hole portion 111g (see FIG. 6), whereby the pair of first framework members 111A and 111B are connected. Next, the pair of second framework members 112A and 112B is disposed so as to extend in the vehicle width direction, and both ends of the second auxiliary member 152 are inserted into the second hole portion 112e (see FIG. 8), whereby the pair of second framework members 112A and 112B are connected. Next, by mechanically engaging the first engagement portion 111e with the second engagement portion 112b (an example of a mechanical joining method), the pair of first framework members 111A and 111B and the pair of second framework members 112A and 112B are joined to form a frame 110 having a rectangular frame shape when viewed from the vehicle vertical direction and defining the through hole TH inside (see FIG. 4).

At this time, preferably, the pair of first framework members 111A and 111B is heated before both ends of the first auxiliary member 151 are inserted into the first hole portion 111g (see FIG. 6). Accordingly, the size of the first hole portion 111g (see FIG. 6) is enlarged, and both ends of the first auxiliary member 151 can be easily inserted. In addition, when the pair of first framework members 111A and 111B returns to room temperature, the size of the first hole portion 111g (see FIG. 6) is reduced, and the pair of first framework members 111A and 111B and the first auxiliary member 151 are firmly connected. As a modification, the first auxiliary member 151 may be cooled before both ends of the first auxiliary member 151 are inserted into the first hole portion 111g (see FIG. 6). In addition, the pair of first framework members 111A and 111B may be heated before the pair of first framework members 111A and 111B and the pair of second framework members 112A and 112B are mechanically joined. In this case, as described above, the first engagement portion 111b and the second engagement portion 112b are firmly engaged with each other. As a further modification, the pair of first framework members 111A and 111B may be heated before the pair of first framework members 111A and 111B and the pair of second framework members 112A and 112B are mechanically joined.

Referring to FIG. 13, the member to be formed 120 is disposed on the table 55 to be superposed on the frame 110. It should be noted that the same reference numeral 120 is used for the member to be formed and the tray, which means that the state before forming is the member to be formed and the state after forming is the tray.

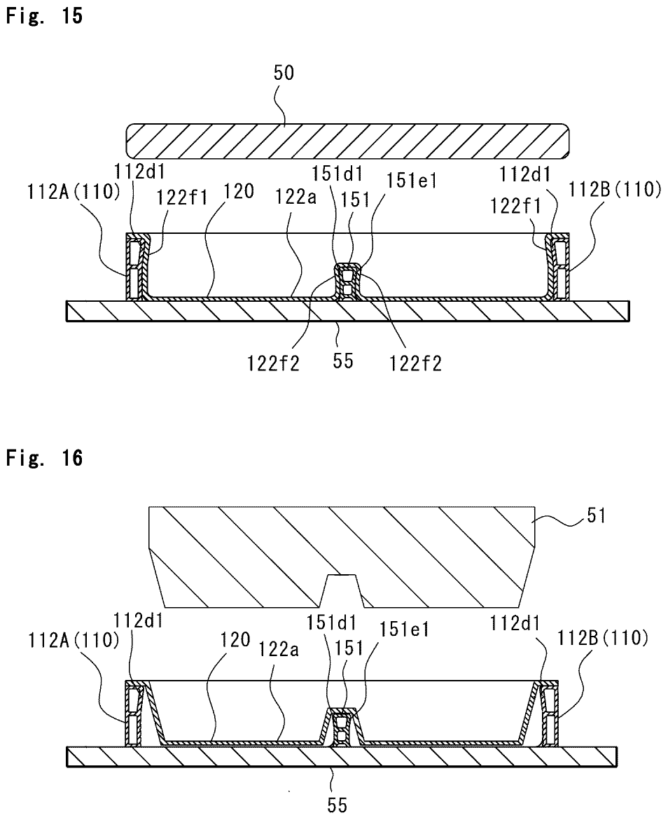

Next, referring to FIGS. 14 and 15, pressure is applied to the member to be formed 120 from the side opposite to that of the frame 110 (that is, the upper side), and the member to be formed 120 is pressed against the frame 110 to bulge inside the through hole TH. Then, the member to be formed 120 is thereby deformed into a tray 120 having a bathtub shape, and brought into pressure contact with the frame 110. At this time, the member to be formed 120 is brought into pressure contact also with the first auxiliary member 151 and the second auxiliary member 152. As a result, the tray 120, the frame 110, the first auxiliary member 151, and the second auxiliary member 152 are integrated.

In the present embodiment, the member to be formed 120 is pressurized by a pressure-forming method (rubber bulging method) using an elastic body. The pressure-forming method refers to a method of forming a member by gas or liquid pressure. In the present embodiment, in the rubber bulging method, a hydraulic transmission elastic body (elastic body) 50 that is elastically deformable by injection of liquid using pressure of the liquid is used. The hydraulic transmission elastic body 50 may have a structure in which only a lower surface of a metal chamber containing a liquid such as water or oil is closed with an elastic film, for example. In such a hydraulic transmission elastic body 50, the elastic film is deformed by adjusting the pressure of the liquid, and forming can be performed without the liquid coming into direct contact with the member to be formed 120.

Referring to FIGS. 13 and 14, in the present embodiment, the frame 110, the member to be formed 120, and the hydraulic transmission elastic body 50 are disposed so as to be superposed on and in contact with the table 55 in this order. Next, by injecting the pressurized liquid into the hydraulic transmission elastic body 50, the member to be formed 120 is pressurized from the side opposite to that of the frame 110 through the hydraulic transmission elastic body 50 and pressed against the frame 110. Then, the hydraulic transmission elastic body 50 is bulged inside the through hole TH, thereby deforming the member to be formed 120 into a tray having a bathtub shape. Preferably, pressurization of the member to be formed 120 by the rubber bulging method is performed in a state where the member to be formed 120 is heated and softened. In this case, due to the softening of the member to be formed 120, cracking during forming the tray 120 can be further suppressed.

In addition, the hydraulic transmission elastic body 50 may be bulged twice inside the through hole TH. That is, in the first round of bulging, pressure is applied to the member to be formed 120 from the side opposite to that of the frame 110, and the member to be formed 120 is pressed against the frame 110 to cause the hydraulic transmission elastic body 50 to bulge inside the through hole TH. Then, the member to be formed 120 is thereby deformed into a tray 120 having a substantial bathtub shape. In the second round of bulging, pressure is applied to the member to be formed 120 from the side opposite to that of the frame 110, and the member to be formed 120 is pressed against the frame 110 to cause the hydraulic transmission elastic body 50 to bulge inside the through hole TH. Then, the member to be formed 120 is thereby deformed into a tray 120 having a bathtub shape, and brought into pressure contact with the frame 110. In this case, since the step of deforming the tray in accordance with the shape of the frame is performed twice, distortion is less likely to occur and formability can be improved as compared with the case of deforming the tray once.

Referring to FIG. 15, when the pressurizing force is released after the member to be formed 120 is deformed into the bathtub-shaped tray 120, the hydraulic transmission elastic body 50 is restored to a shape in the natural state. Therefore, the hydraulic transmission elastic body 50 can be easily removed from the inside of the tray 120. After the hydraulic transmission elastic body 50 is removed, as shown in FIG. 2, the undercover 140 is joined, the battery 30 is housed, and then the top cover 130 is joined to form the battery case 100.

In the present embodiment, an R shape (rounded shape) is imparted to the inner side of the upper portion of the frame 110. The R-shape promotes the inflow of the material into the inside of the member to be formed 120 in the forming. However, in view of the design of the extruded material or the like, a small round shape may be formed also on a portion other than the inner side of the upper portion of the frame 110. In the illustration, such a small round shape is omitted.

In the present embodiment, when the member to be formed 120 is formed into the bathtub-shaped tray 120, negative angle forming is performed. Here, the negative angle is a term often used in the forming field using a die, and indicates that the die draft angle in the formed member is less than zero (negative). In the present embodiment, the tray 120 is pressed against the inclined surface 112d1 of each of the pair of second framework members 112A and 112B by pressurization from the hydraulic transmission elastic body 50, and the tray 120 is provided with the negative angle portion 122f1 in which a negative angle directed upward in the vehicle vertical direction from the bottom wall 122a of the tray 120 toward the inside in the horizontal direction is formed. In addition, similarly, the tray 120 is pressed against the upper side wall 151d1, 151e1 of the first auxiliary member 151, and the tray 120 is provided with the negative angle portion 122f1 in which a negative angle directed upward in the vehicle vertical direction from the bottom wall 122a of the tray 120 toward the horizontal direction (vehicle front-rear direction) is formed.

According to the battery case 100 and the method for manufacturing the same as described above, the following actions and effects are produced.

Since the pair of first framework members 111A and 111B and the pair of second framework members 112A and 112B are joined by a mechanical joining method, and the first auxiliary member 151 and the second auxiliary member 152 are joined by a mechanical joining method, complicated welding is not required. Therefore, it is possible to suppress a decrease in assembly accuracy of the frame 110 due to welding thermal strain, and to simply form the frame 110 and the cross member 150. In addition, since the tray 120 is formed in a bathtub shape, there is no joint in the tray 120, and high sealing performance capable of preventing water from entering from a road surface or the like can be secured. In addition, since the cross member 150 supports the frame 110 from the inside, high rigidity can be secured.

In addition, since the first engagement portion 111e and the second engagement portion 112b are engaged with each other, the pair of first framework members 111A and 111B and the pair of second framework members 112A and 112B are directly joined. Therefore, the frame 110 can be simply formed. Furthermore, since accurate positioning is performed by fitting structurally involving positional restraint, dimensional accuracy and joining accuracy can be improved.

Since the recessed portions 111f and 112c recessed in the vehicle vertical direction are fitted to each other, the positions in the horizontal direction of the pair of first framework members 111A and 111B and the pair of second framework members 112A and 112B are restrained. In addition, since the insertion portion 112k is inserted into the insertion hole 111m, it is possible to suppress release from engagement. Furthermore, since the bathtub-shaped tray 120 is disposed with respect to the frame 110 from above, the first engagement portion 111e and the second engagement portion 112b can be covered with the tray 120. Therefore, the position in the vehicle vertical direction is also restrained, and release from engagement can be suppressed.

Since the gap between the first engagement portion 111e and the second engagement portion 112b decreases as they are engaged, assembly is facilitated, and furthermore, backlash after assembly can be suppressed or prevented.

The configuration in which the first auxiliary member 151 is inserted into the first hole portion 111g is simple and low-cost, and the connection of the pair of first framework members 111A and 111B by the first auxiliary member 151 can be specifically designed.

Since the gap between the first hole portion 111g and the first auxiliary member 151 decreases as they are engaged, assembly is facilitated, and furthermore, backlash after assembly can be suppressed or prevented.

The configuration in which the second auxiliary member 152 is inserted into the second hole portion 112e is simple and low-cost, and the connection of the pair of second framework members 112A and 112B by the second auxiliary member 152 can be specifically designed.

Since the gap between the second hole portion 112e and the second auxiliary member 152 decreases as they are engaged, assembly is facilitated, and furthermore, backlash after assembly can be suppressed or prevented.

The rigidity of the entire frame 110 can be improved by joining the first auxiliary member 151 and the second auxiliary member 152.

By fitting the recessed portions recessed in the vehicle vertical direction to each other, the horizontal positions of the first auxiliary member 151 and the second auxiliary member 152 are restrained. In addition, since the bathtub-shaped tray 120 is disposed with respect to the frame 110 from above, the third engagement portion 151f and the fourth engagement portion 152f can be covered with the tray 120. Therefore, the position in the vehicle vertical direction is also restrained, and release from engagement can be suppressed.

Since the gap between the third engagement portion 151f and the fourth engagement portion 152f decreases as they are engaged, assembly is facilitated, and furthermore, backlash after assembly can be suppressed or prevented.

Since the top surfaces 111l and 112j are flush with each other, the generation of a gap between the frame 110 and the tray 120 can be suppressed or prevented. Therefore, the sealing performance can be improved.

Since the first partition wall 111c and the second partition wall 112a are formed at the identical height, when a collision load in the horizontal direction is applied to the frame 110, the collision load can be transmitted to the entire frame through the first partition wall 111c and the second partition wall 112a. Therefore, the collision load can be absorbed by the entire frame 110, and the crashworthiness can be improved.

Since the tray 120 is in pressure contact with the frame 110, the frame 110 and the tray 120 can be easily integrated without requiring welding.

Since the negative angle portion 122f1, 122f2 is provided, the negative angle portion 122f1, 122f2 is caught by the frame 110 even when an upward force is applied to the tray 120, so that the tray 120 can be prevented from being detached from the frame 110. That is, the pressure contact between the tray 120 and the frame 110 can be prevented from being released.

Since the first hole portion 111g expands when the pair of first framework members 111A and 111B is heated, or the first auxiliary member 151 contracts when cooled, the first auxiliary member 151 can be easily inserted into the first hole portion 111g. In addition, when the pair of first framework members 111A and 111B or the first auxiliary member 151 returns to normal temperature, the pair of first framework members 111A and 111B and the auxiliary member 151 can be firmly joined. Similarly, the pair of first framework members 111A and 111B and the pair of second framework members 112A and 112B can also be easily and firmly joined.

Since the hydraulic transmission elastic body 50 is used, it is possible to easily bulge and deform the member to be formed 120 to such a complex shape in which the first auxiliary member 151 is disposed. In other words, the bulging amount of the member to be formed 120 can be increased, and the tray 120 can be firmly brought into pressure contact with the frame 110.

Referring to FIG. 16, preforming may be performed using the preforming die 51 before forming the member to be formed 120 into a bathtub-shaped tray by the hydraulic transmission elastic body 50. In the preforming, the member to be formed 120 is formed into the shape of a tray 120 that is generally or completely bathtub-shaped. Therefore, the preforming die 51 has a forming surface having a shape complementary to the shape of the tray 120 to be formed. It should be noted that the preforming die 51 is made of metal and does not execute the negative angle forming described above.

The step of deforming the tray 120 in accordance with the shapes of the frame 110 and the cross member 150 is performed at least twice by the above-described preforming and subsequently performed main forming (forming of the hydraulic transmission elastic body 50). Therefore, as compared with the case where the member to be formed 120 is deformed at one time, distortion is less likely to occur, and formability can be improved.

### Second Embodiment

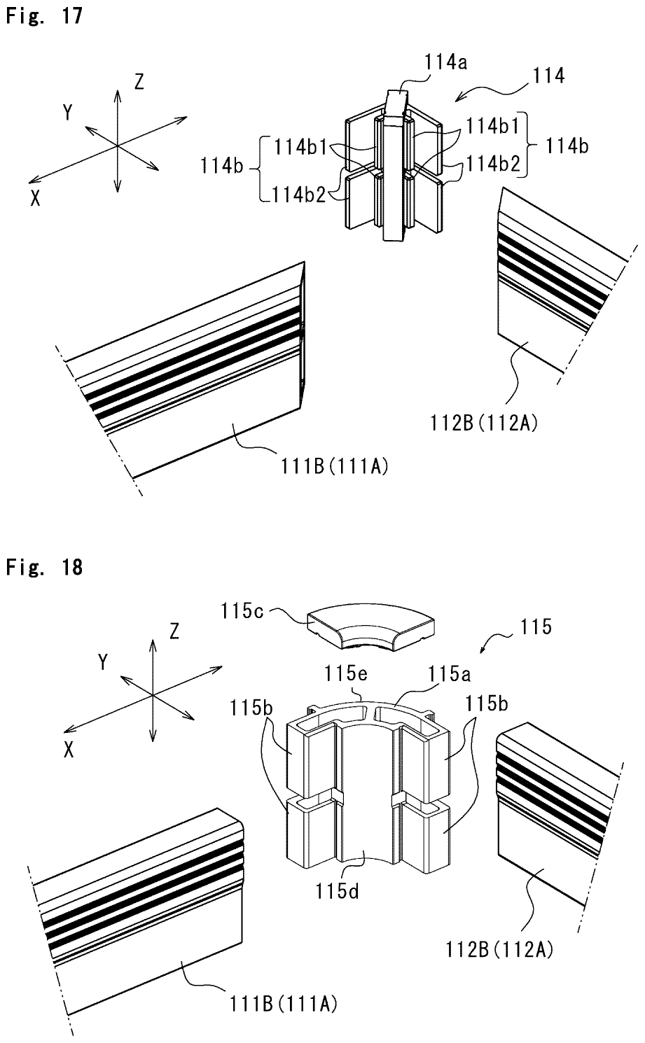

Referring to FIG. 17, the configuration of a battery case 100 according to a second embodiment of the present disclosure is different from that of the first embodiment in the following points. Other configurations of the present embodiment are similar to those of the first embodiment, and the elements identical or similar to those of the first embodiment are denoted by the same reference numerals. It should be noted that in FIG. 17, only the joint portion between the first framework member 111B and the second framework member 112B is enlarged and shown, but the other joint portions also have the same configuration.

In the second embodiment, the battery case 100 further includes a joining member 114 for joining the pair of first framework members 111A and 111B and the pair of second framework members 112A and 112B.

The joining member 114 includes a rectangular-parallelepiped-shaped base portion 114a and a protruding portion 114b protruding from the base portion 114a. The protruding portion 114b includes four inner protruding pieces 114b1 and four outer protruding pieces 114b2 protruding more greatly from the base portion 114a than the four inner protruding pieces 114b1. When viewed from the vehicle vertical direction, the four outer protruding pieces 114b2 are positioned outside in the vehicle width direction or outside in the vehicle front-rear direction of the four inner protruding pieces 114b1.

In the second embodiment, each of the pair of first framework members 111A and 111B does not include the first engagement portion 111e (see FIG. 5), and each of the pair of second framework members 112A and 112B does not include the second engagement portion 112b (see FIG. 5). In addition, either end of each of the pair of first framework members 111A and 111B is obliquely cut so as to correspond to the shape of the joining member 114. Either end of each of the pair of second framework members 112A and 112B is also obliquely cut so as to correspond to the shape of the joining member 114.

The four inner protruding pieces 114b1 and the four outer protruding pieces 114b2 are inserted into the pair of first framework members 111A and 111B and the pair of second framework members 112A and 112B. Therefore, when the pair of first framework members 111A and 111B, the pair of second framework members 112A and 112B, and the joining member 114 are assembled as the frame 110, only the base portion 114a of the joining member 114 can be visually recognized, and the four inner protruding pieces 114b1 and the four outer protruding pieces 114b2 cannot be visually recognized.

By inserting the protruding portion 114b into the pair of first framework members 111A and 111B, the pair of first framework members 111A and 111B and the joining member 114 are mechanically joined. In addition, by inserting the protruding portion 114b into the pair of second framework members 112A and 112B, the pair of second framework members 112A and 112B and the joining member 114 are mechanically joined. In this manner, the pair of first framework members 111A and 111B and the pair of second framework members 112A and 112B are indirectly joined through the joining member 114.

In the second embodiment, without complicated processing being performed on the pair of first framework members 111A and 111B and the pair of second framework members 112A and 112B, which are extruded materials, the pair of first framework members 111A and 111B and the pair of second framework members 112A and 112B can be joined. As described above, the mechanical joining of the pair of first framework members 111A and 111B and the pair of second framework members 112A and 112B includes not only a direct mode as in the first embodiment but also an indirect mode as in the second embodiment.

Referring to FIG. 18, in a modification of the second embodiment, both end portions of the pair of first framework members 111A and 111B are cut perpendicularly to the vehicle front-rear direction. Similarly, both end portions of the pair of second framework members 112A and 112B are cut perpendicularly to the vehicle width direction. Therefore, as compared with the above-described embodiments, the pair of first framework members 111A and 111B and the pair of second framework members 112A and 112B can be easily manufactured.

In the present modification, the battery case 100 further includes a joining member 115 for joining the pair of first framework members 111A and 111B and the pair of second framework members 112A and 112B.

The joining member 115 includes an annular fan-shaped columnar base portion 115a. In addition, the joining member 115 includes four protruding pieces 115b protruding from the base portion 115a. The joining member 115 is joined to the pair of first framework members 111A and 111B and the pair of second framework members 112A and 112B in the four protruding pieces 115b by a mechanical joining method. To an upper surface of the base portion 115a, a cover 115c covering the upper surface is attached. In addition, in the base portion 115a, a surface positioned inside the frame 110 and a surface positioned outside the frame are curved surfaces 115d and 115e, respectively. As described above, the shape of the joining member 115 can vary.

The present disclosure may include the following aspects.

### Aspect 1

An electric vehicle battery case including:
a frame formed in a rectangular frame shape when viewed in a vehicle vertical direction, the frame configured to define a space inside;
a cross member disposed inside the frame to divide the space; and
a tray having a bathtub shape, the tray configured to house a battery, the tray disposed at least partially in the space of the frame, in which
the frame includes a pair of first framework members, which is an aluminum extruded material, extending in a vehicle front-rear direction, and a pair of second framework members, which is an aluminum extruded material, extending in a vehicle width direction,
the cross member includes a first auxiliary member that is an aluminum extruded material and connects the pair of first framework members, and a second auxiliary member that is an aluminum extruded material and connects the pair of second framework members,
the pair of first framework members and the pair of second framework members are mechanically joined to each other, and
the first auxiliary member and the second auxiliary member are mechanically joined.

### Aspect 2

The electric vehicle battery case according to aspect 1, in which
the pair of first framework members includes a first engagement portion,
the pair of second framework members includes a second engagement portion,
at least one of the first engagement portion or the second engagement portion has a recessed shape, and
the pair of first framework members and the pair of second framework members are directly joined by engagement of the first engagement portion and the second engagement portion.

### Aspect 3

The electric vehicle battery case according to aspect 2, in which
the second engagement portion includes a recessed portion having a shape recessed upward in the vehicle vertical direction and an insertion portion constituting a part of the recessed portion and having a shape protruding downward in the vehicle vertical direction, and
the first engagement portion includes a recessed portion having a shape recessed downward in the vehicle vertical direction, and an insertion hole which is aligned with the insertion portion and into which the insertion portion is inserted.

### Aspect 4

The electric vehicle battery case according to aspect 3, in which
the recessed portion of the first engagement portion includes a first inclined portion inclined to narrow at a first angle downward in the vehicle vertical direction as viewed in the vehicle width direction, and
the second engagement portion includes a second inclined portion that is aligned with the first inclined portion and is inclined to narrow at the first angle downward in the vehicle vertical direction as viewed in the vehicle width direction.

### Aspect 5

The electric vehicle battery case according to any one of aspects 1 to 4, in which
the pair of first framework members includes a first hole portion provided to face the space, and
both ends of the first auxiliary member are inserted into the first hole portion.

### Aspect 6

The electric vehicle battery case according to aspect 5, in which
the first hole portion includes a third inclined portion inclined to narrow at a second angle downward in the vehicle vertical direction as viewed in the vehicle width direction, and
the first auxiliary member includes a fourth inclined portion that is aligned with the third inclined portion and is inclined to narrow at the second angle downward in the vehicle vertical direction as viewed in the vehicle width direction.

### Aspect 7

The electric vehicle battery case according to aspect 5, in which
the pair of second framework members includes a second hole portion provided to face the space, and
both ends of the second auxiliary member are inserted into the second hole portion.

### Aspect 8

The electric vehicle battery case according to aspect 7, in which
the second hole portion includes a fifth inclined portion inclined to narrow at a third angle upward in the vehicle vertical direction as viewed in the vehicle front-rear direction, and
the second auxiliary member includes a sixth inclined portion that is aligned with the fifth inclined portion and is inclined to narrow at the third angle upward in the vehicle vertical direction as viewed in the vehicle front-rear direction.

### Aspect 9

The electric vehicle battery case according to aspect 7, in which
the first auxiliary member includes a third engagement portion,
the second auxiliary member includes a fourth engagement portion,
at least one of the third engagement portion or the fourth engagement portion has a recessed shape, and
the first auxiliary member and the second auxiliary member are joined by engagement of the third engagement portion and the fourth engagement portion.

### Aspect 10

The electric vehicle battery case according to aspect 9, in which
the third engagement portion includes a recessed portion having a shape recessed downward in the vehicle vertical direction, and
the fourth engagement portion includes a recessed portion having a shape recessed upward in the vehicle vertical direction.

### Aspect 11

The electric vehicle battery case according to aspect 10, in which
the third engagement portion includes a seventh inclined portion inclined to narrow at a fourth angle downward in the vehicle vertical direction as viewed in the vehicle front-rear direction, and
the second auxiliary member includes an eighth inclined portion that is aligned with the seventh inclined portion and is inclined to narrow at the fourth angle downward in the vehicle vertical direction as viewed in the vehicle front-rear direction.

### Aspect 12

The electric vehicle battery case according to aspect 10, in which
the fourth engagement portion includes a ninth inclined portion inclined to narrow at a fifth angle upward in the vehicle vertical direction as viewed in the vehicle width direction, and
the first auxiliary member includes a tenth inclined portion that is aligned with the ninth inclined portion and is inclined to narrow at the fifth angle upward in the vehicle vertical direction as viewed in the vehicle width direction.

### Aspect 13

The electric vehicle battery case according to any one of aspects 1 to 4, in which
the pair of first framework members has a first top surface that is positioned at an uppermost position in the vehicle vertical direction and extends in a horizontal direction,
the pair of second framework members has a second top surface that is positioned at an uppermost position in the vehicle vertical direction and extends in a horizontal direction, and
the first top surface and the second top surface are flush with each other.

### Aspect 14

The electric vehicle battery case according to any one of aspects 1 to 13, in which
the pair of first framework members has a tubular shape whose inside is partitioned in the vehicle vertical direction by a first partition wall extending in a horizontal direction,
the pair of second framework members has a tubular shape whose inside is partitioned in the vehicle vertical direction by a second partition wall extending in a horizontal direction, and
the first partition wall and the second partition wall are disposed at an identical height in the vehicle vertical direction.

### Aspect 15

The electric vehicle battery case according to aspect 1, further including a joining member for joining the pair of first framework members and the pair of second framework members, and in which the pair of first framework members and the pair of second framework members are indirectly joined through the joining member by joining the pair of first framework members and the joining member by a mechanical joining method and joining the pair of second framework members and the joining member by a mechanical joining method.

### Aspect 16

The electric vehicle battery case according to any one of aspects 1 to 15, in which the tray is in pressure contact with the frame.

### Aspect 17

The electric vehicle battery case according to any one of aspects 1 to 16, in which a negative angle portion in which a negative angle directed at least partially inward in a horizontal direction from a bottom wall of the tray upward in the vehicle vertical direction is formed is provided.

### Aspect 18

A method for manufacturing an electric vehicle battery case, the method including:
preparing a flat plate-shaped member to be formed, a pair of first framework members that is an aluminum extruded material, a pair of second framework members that is an aluminum extruded material, a first auxiliary member that is an aluminum extruded material, and a second auxiliary member that is an aluminum extruded material;
disposing the pair of first framework members so as to extend in a vehicle front-rear direction;
disposing the pair of second framework members so as to extend in a vehicle width direction;
mechanically joining the pair of first framework members and the pair of second framework members, thereby forming a frame that has a rectangular frame shape when viewed from a vehicle vertical direction and defines a space inside, and mechanically joining the first auxiliary member that connects the pair of first framework members and the second auxiliary member that connects the pair of second framework members so as to divide the space, thereby forming a cross member;
superposing and disposing the member to be formed on the frame and the cross member; and
applying pressure to the member to be formed from a side opposite to that of the frame and the cross member, pressing the member to be formed against the frame and the cross member to bulge the member to be formed in the space, thereby deforming the member to be formed into a tray having a bathtub shape and bringing the member to be formed into pressure contact with the frame and the cross member.

### Aspect 19

The method for manufacturing an electric vehicle battery case according to aspect 18, further including:
further preparing an elastic body into which liquid is to be injected;
disposing the elastic body so as to be in contact with the member to be formed; and
injecting pressurized liquid into the elastic body, thereby applying pressure to the member to be formed from a side opposite to that of the frame and the cross member, pressing the member to be formed against the frame and the cross member to bulge the member to be formed in the space, thereby deforming the member to be formed into a tray having a bathtub shape and bringing the member to be formed into pressure contact with the frame and the cross member.

### Aspect 20

The method for manufacturing an electric vehicle battery case according to aspect 19, further including performing preforming using a preforming die before, by the elastic body, deforming and bringing the member to be formed into pressure contact.

This application claims priority based on Japanese Patent Application No. 2022-107707 filed on Jul. 4, 2022. Japanese Patent Application No. 2022-107707 is incorporated herein by reference.

1. An electric vehicle battery case comprising:
a frame formed in a rectangular frame shape when viewed in a vehicle vertical direction, the frame configured to define a space inside;
a cross member disposed inside the frame to divide the space; and
a tray having a bathtub shape, the tray configured to house a battery, the tray disposed at least partially in the space of the frame, wherein
the frame includes a pair of first framework members, which is an aluminum extruded material, extending in a vehicle front-rear direction, and a pair of second framework members, which is an aluminum extruded material, extending in a vehicle width direction,
the cross member includes a first auxiliary member that is an aluminum extruded material and connects the pair of first framework members, and a second auxiliary member that is an aluminum extruded material and connects the pair of second framework members,
the pair of first framework members and the pair of second framework members are mechanically joined to each other, and
the first auxiliary member and the second auxiliary member are mechanically joined.

2. The electric vehicle battery case according to claim 1, wherein
the pair of first framework members includes a first engagement portion,
the pair of second framework members includes a second engagement portion,
at least one of the first engagement portion or the second engagement portion has a recessed shape, and
the pair of first framework members and the pair of second framework members are directly joined by engagement of the first engagement portion and the second engagement portion.

3. The electric vehicle battery case according to claim 2, wherein
the second engagement portion includes a recessed portion having a shape recessed upward in the vehicle vertical direction and an insertion portion constituting a part of the recessed portion and having a shape protruding downward in the vehicle vertical direction, and
the first engagement portion includes a recessed portion having a shape recessed downward in the vehicle vertical direction, and an insertion hole which is aligned with the insertion portion and into which the insertion portion is inserted.

4. The electric vehicle battery case according to claim 3, wherein
the recessed portion of the first engagement portion includes a first inclined portion inclined to narrow at a first angle downward in the vehicle vertical direction as viewed in the vehicle width direction, and
the second engagement portion includes a second inclined portion that is aligned with the first inclined portion and is inclined to narrow at the first angle downward in the vehicle vertical direction as viewed in the vehicle width direction.

5. The electric vehicle battery case according to claim 1, further comprising a joining member for joining the pair of first framework members and the pair of second framework members, wherein the pair of first framework members and the pair of second framework members are indirectly joined through the joining member by joining the pair of first framework members and the joining member by a mechanical joining method and joining the pair of second framework members and the joining member by a mechanical joining method.

6. The electric vehicle battery case according to claim 1, wherein
the pair of first framework members includes a first hole portion provided to face the space, and
both ends of the first auxiliary member are inserted into the first hole portion.

7. The electric vehicle battery case according to claim 6, wherein
the first hole portion includes a third inclined portion inclined to narrow at a second angle downward in the vehicle vertical direction as viewed in the vehicle width direction, and
the first auxiliary member includes a fourth inclined portion that is aligned with the third inclined portion and is inclined to narrow at the second angle downward in the vehicle vertical direction as viewed in the vehicle width direction.

8. The electric vehicle battery case according to claim 1, wherein
the pair of second framework members includes a second hole portion provided to face the space, and
both ends of the second auxiliary member are inserted into the second hole portion.

9. The electric vehicle battery case according to claim 8, wherein
the second hole portion includes a fifth inclined portion inclined to narrow at a third angle upward in the vehicle vertical direction as viewed in the vehicle front-rear direction, and
the second auxiliary member includes a sixth inclined portion that is aligned with the fifth inclined portion and is inclined to narrow at the third angle upward in the vehicle vertical direction as viewed in the vehicle front-rear direction.

10. The electric vehicle battery case according to claim 1, wherein
the first auxiliary member includes a third engagement portion,
the second auxiliary member includes a fourth engagement portion,
at least one of the third engagement portion or the fourth engagement portion has a recessed shape, and
the first auxiliary member and the second auxiliary member are joined by engagement of the third engagement portion and the fourth engagement portion.

11. The electric vehicle battery case according to claim 10, wherein
the third engagement portion includes a recessed portion having a shape recessed downward in the vehicle vertical direction, and
the fourth engagement portion includes a recessed portion having a shape recessed upward in the vehicle vertical direction.

12. The electric vehicle battery case according to claim 11, wherein
the recessed portion of the third engagement portion includes a seventh inclined portion inclined to narrow at a fourth angle downward in the vehicle vertical direction as viewed in the vehicle front-rear direction, and
the second auxiliary member includes an eighth inclined portion that is aligned with the seventh inclined portion and is inclined to narrow at the fourth angle downward in the vehicle vertical direction as viewed in the vehicle front-rear direction.

13. The electric vehicle battery case according to claim 11, wherein
the recessed portion of the fourth engagement portion includes a ninth inclined portion inclined to narrow at a fifth angle upward in the vehicle vertical direction as viewed in the vehicle width direction, and
the first auxiliary member includes a tenth inclined portion that is aligned with the ninth inclined portion and is inclined to narrow at the fifth angle upward in the vehicle vertical direction as viewed in the vehicle width direction.

14. The electric vehicle battery case according to claim 1, wherein
the pair of first framework members has a first top surface that is positioned at an uppermost position in the vehicle vertical direction and extends in a horizontal direction,
the pair of second framework members has a second top surface that is positioned at an uppermost position in the vehicle vertical direction and extends in a horizontal direction, and
the first top surface and the second top surface are flush with each other.

15. The electric vehicle battery case according to claim 1, wherein
the pair of first framework members has a tubular shape whose inside is partitioned in the vehicle vertical direction by a first partition wall extending in a horizontal direction,
the pair of second framework members has a tubular shape whose inside is partitioned in the vehicle vertical direction by a second partition wall extending in a horizontal direction, and
the first partition wall and the second partition wall are disposed at an identical height in the vehicle vertical direction.

16. The electric vehicle battery case according to claim 1, wherein the tray is in pressure contact with the frame.

17. The electric vehicle battery case according to claim 1, wherein a negative angle portion in which a negative angle directed at least partially inward in a horizontal direction from a bottom wall of the tray upward in the vehicle vertical direction is formed is provided.

18. A method for manufacturing an electric vehicle battery case, the method comprising:
preparing a flat plate-shaped member to be formed, a pair of first framework members that is an aluminum extruded material, a pair of second framework members that is an aluminum extruded material, a first auxiliary member that is an aluminum extruded material, and a second auxiliary member that is an aluminum extruded material;
disposing the pair of first framework members so as to extend in a vehicle front-rear direction;
disposing the pair of second framework members so as to extend in a vehicle width direction;
mechanically joining the pair of first framework members and the pair of second framework members, thereby forming a frame that has a rectangular frame shape when viewed from a vehicle vertical direction and defines a space inside, and mechanically joining the first auxiliary member that connects the pair of first framework members and the second auxiliary member that connects the pair of second framework members so as to divide the space, thereby forming a cross member;
superposing and disposing the member to be formed on the frame and the cross member; and
applying pressure to the member to be formed from a side opposite to that of the frame and the cross member, pressing the member to be formed against the frame and the cross member to bulge the member to be formed in the space, thereby deforming the member to be formed into a tray having a bathtub shape and bringing the member to be formed into pressure contact with the frame and the cross member.

19. The method for manufacturing an electric vehicle battery case according to claim 18, further comprising:
further preparing an elastic body into which liquid is to be injected;
disposing the elastic body so as to be in contact with the member to be formed; and
injecting pressurized liquid into the elastic body, thereby applying pressure to the member to be formed from a side opposite to that of the frame and the cross member, pressing the member to be formed against the frame and the cross member to bulge the member to be formed in the space, thereby deforming the member to be formed into a tray having a bathtub shape and bringing the member to be formed into pressure contact with the frame and the cross member.

20. The method for manufacturing an electric vehicle battery case according to claim 19, further comprising performing preforming using a preforming die before, by the elastic body, deforming and bringing the member to be formed into pressure contact.
